(19) United States
(12) Patent Application Publication
(10) Pub. No.: US 2008/0148248 A1
(43) Pub. Date: Jun. 19, 2008

(54) Automatic software maintenance with change requests

(76) Inventors: Michael Volkmer, Heidelberg (DE); Marco Bertolini, Hirschberg (DE)

Correspondence Address: SAP/BLAKELY, 1279 OAKMEAD PARKWAY, SUNNYVALE, CA, 94085-4040, US

(21) Appl. No.: 11/639,870

(22) Filed: Dec. 15, 2006

(51) Int. Cl. G06F 9/44

(52) U.S. Cl. 717/168

(57) ABSTRACT

System-level information is retrieved from a remote system and a request is automatically sent to an update agent for a list of software updates for the remote system. The request includes the retrieved system-level information. The update agent provides a list of available software updates that is filtered based at least in part on the system-level information. The filtered list of software updates is then sent to the remote system. The enterprise system receives user input indicating a selection of one or more software updates from the filtered list. Selected software updates are incorporated into a business action.

### FIELD

Embodiments of the invention relate to software maintenance and more particularly to automatic software maintenance with change requests.

### BACKGROUND

Many businesses and other entities use large and complex software systems (often referred to as a business suite) in their operations. These software systems usually offer a variety of interrelated applications and functionality. Maintaining large software systems can be both challenging and expensive, particularly because these systems are often customized to a unique business landscape.

Managing software updates often involves many tasks that can be time consuming. For example, a customer might have to manually check for software updates by accessing an update server through a web services connection or by visiting a website. In order to know which software updates are relevant, the customer needs to keep track of current product versions, support packages, patches, etc. installed in various sections of the system landscape, if not the entire system landscape. Maintaining this information likely involves periodic surveys of the system landscape along with manual data entry to record the information.

Once a customer has all of the necessary information, the customer can search for relevant software updates (i.e., updates that are new or otherwise not yet installed) Given that the update server is likely to contain software updates and other information for a wide variety of products, programs, applications, it can be arduous to navigate through all of the choices. In addition, new product versions, support packages, news, and other information are continually being updated on the update server, but not necessarily at the same time. Customized searching alleviates the burden slightly, but still requires the customer to enter a lot of information, which can be very time consuming. Furthermore, all of these actions are prone to human error, which can lead to inaccurate search results or even installing the wrong software updates, thereby increasing time and cost to maintain the system landscape.

### SUMMARY

A method to facilitate software update management for a remote system is described herein. An enterprise server retrieves system-level information from the remote system and a request is automatically sent to an update agent for a list of software updates for the remote system. The request includes the retrieved system-level information so that the update agent can provide a list of available software updates that is filtered based at least in part on the system-level information. In other words, the update agent only provides software updates that are pertinent/relevant to the remote system based on the settings, versions, configurations, etc., of the system. The filtered list of software updates is provided to the enterprise server. Within the enterprise server, a user interface (UI) allows a user (e.g., an administrator) to select software updates from the filtered list to be applied to the remote system. Selected software updates are incorporated into a business action (e.g., a change management process, a postponement action, a rejection action, etc.).

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1A is a block diagram illustrating an embodiment of an update manager.

FIG. 1B is a block diagram illustrating another embodiment of an update manager.

FIG. 2 is a block diagram illustrating a selection agent.

FIG. 3 is a flow diagram illustrating an embodiment of a process to manage software updates.

### DETAILED DESCRIPTION

In one embodiment, a remote system refers to a group of one or more interconnected client devices running a business software suite, such as mySAP Business Suite, available from SAP AG of Walldorf, Germany. For example, company X might use a business software suite in its operations; the software might be used on dozens or even hundreds of client devices within the company. This collection of devices is connected to an enterprise server, which helps to manage and facilitate the use of various applications in the business software suite. Thus, all of company X's client devices may collectively be referred to as a remote system. A remote system does not necessarily require a plurality of interconnected client devices; a single client device (e.g., personal computer) could be a remote system in one embodiment. A remote system may also be referred to as a satellite system, a business system, or a system landscape, for example. While many terms can convey the same or similar meaning, the term “remote system” will be used herein for the purposes of clarity, consistency and ease of description.

A server (e.g., an enterprise server) retrieves system-level information from a remote system. As used herein, “system-level” information refers to information about software installed on the remote system. System-level information can include product versions, software component versions, support package levels, patch levels, etc. In other words, system-level information includes any information that identifies the software running on the remote system. In one embodiment, system-level information is retrieved via a web services connection between the enterprise server and the remote system. Other connections (e.g., intranet, internet, etc.) could also be used in different embodiments.

The retrieved information is automatically sent (e.g., via eXtensible Markup Language (XML), Hypertext Transfer Protocol (HTTP), etc.) to an update server with a request for a list of software updates. The update server is a repository or storage site for downloads and information related to software updates. The update server contains at least the most recent product versions, software component versions, patches, etc. for various applications, including applications associated with a business suite. The update server may also contain text files and/or other support documents that provide installation instructions, tips, warnings, explanation, advice, notes, etc., related to the various software updates.

The update server uses the retrieved system-level information to create a filtered list of relevant software updates and information. For example, if the retrieved system-level information indicates that the remote system is only using application X, version 5.0, the update server would filter out updates related to applications Y and Z. Additionally, the update server would filter out updates and information related to previous versions of application X; only new or previously uninstalled versions of application X (e.g., versions released after version 5.0) would be included in the filtered list.

The filtered list of software updates is sent to the enterprise server. In one embodiment, a selection agent automatically accepts/selects the updates. In another embodiment, a selection user interface (UI) is provided so that a user (e.g., an administrator) can select particular updates from the filtered list to be applied to the remote system. In addition to selecting particular updates, a user can also select an associated business action for each selected update. Business actions might include accepting an update for download, rejecting an update, or postponing a decision on a particular update, etc. In one embodiment, a user selects to incorporate a software update into a change management process.

A change management process allows for controls (e.g., quality controls, organizational controls, etc.) and record-keeping with respect to changes in a system. Changes can be emergency corrections, periodic maintenance (e.g., applying a support package), or implementations and upgrades. In general, a change management process begins when a change is requested by a user (e.g., via a change request). In order to proceed with the change, the change request must be approved by a change manager. If the change request is approved, a developer or an administrator applies the change to a development system. The change is then passed to a test system where a user performs a test. If the test is successful the change is transported into the productive system for which the request was originally made. The complete process is recorded in the change request and is available for reporting.

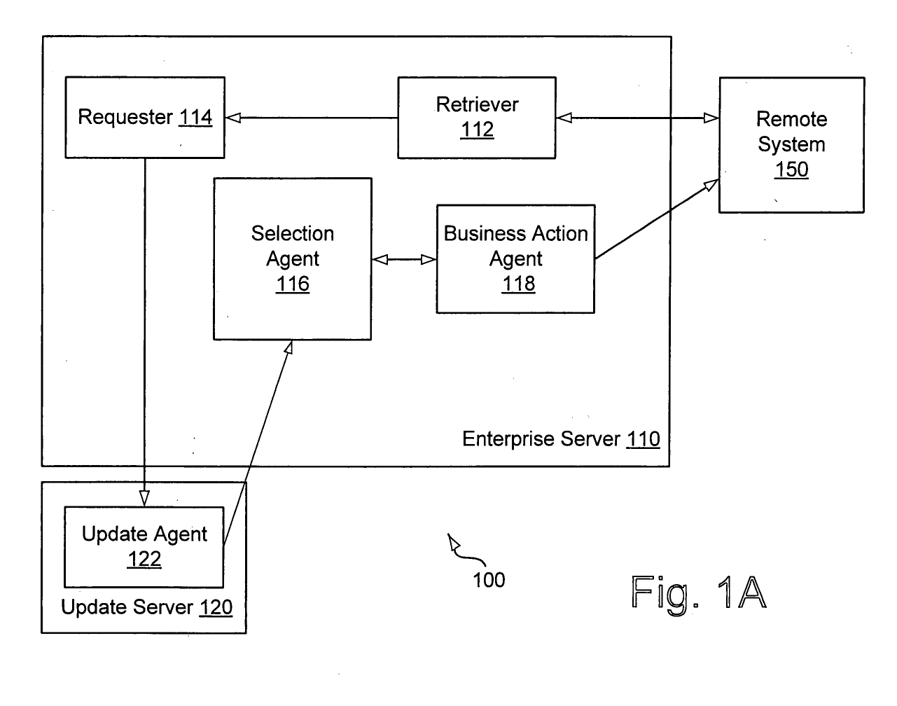

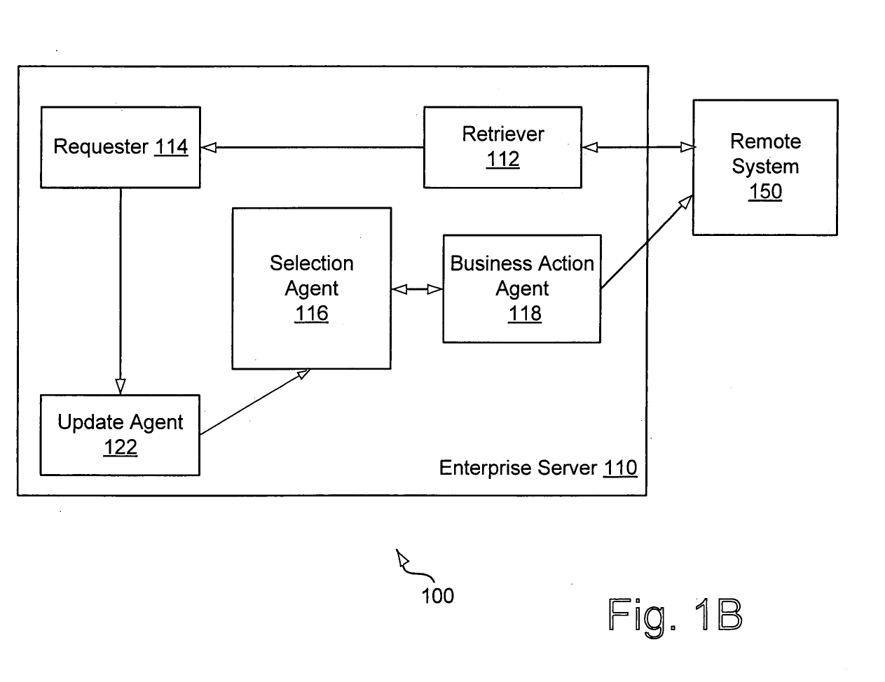

FIG. 1A illustrates an embodiment of an update manager 100. Update manager 100 could be implemented, for example, using SAP Solution Manager, available from SAP AG of Walldorf, Germany. Enterprise server 110 is communicatively coupled to a remote system 150. Enterprise server 110 can be any computer system which performs backend services, often for a large organization. For example, enterprise server 110 manages software updates for remote system 150. Remote system 150 can be any combination of one or more computer devices that use software and can connect to the enterprise server (e.g., personal computers, laptops, personal digital assistants (PDAs), etc.).

A retriever 112 retrieves current system information from remote system 150. System information includes information about the software installed on remote system 150 (e.g., product versions, software component versions, etc.). The system information may also include details about installed patches, administrator programming changes, error logs, etc. The retrieved information is forwarded to a requester 114. Requester 114 automatically sends a request to update agent 122 for a list of software updates for remote system 150.

Software updates include new product versions, software component versions, support packages, patches, etc. Software updates can also include news, notes, text files, etc., related to software changes, error fixes, warnings, etc.

In the embodiment of FIG. 1A, update agent 122 resides on update server 120. In the embodiment of FIG. 1B, update agent 122 is internal to the enterprise server 110. In either case, update agent 122 is responsible for processing the request. The request is processed by filtering available software updates based on the retrieved system information. Thus, update agent 122 generates a filtered list of software updates for remote system 150.

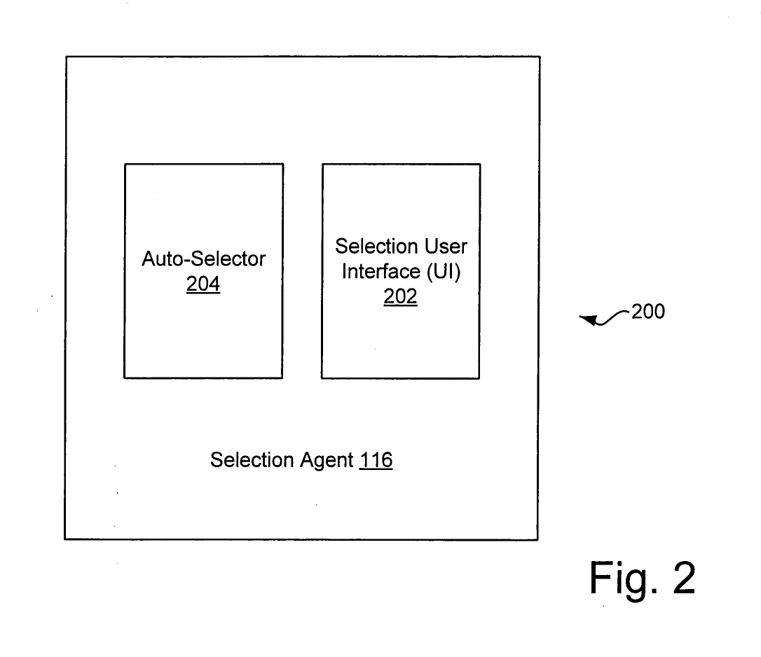

In both FIG. 1A and FIG. 1B, update agent 122 sends the filtered list of software updates to selection agent 116. As seen in FIG. 2, selection agent includes an auto-selector 204 and a selection user interface (UI) 202. Using auto-selector 204, selection agent 116 is capable of receiving the filtered list of software updates from update agent 122 and automatically selecting one or more updates. Auto-selector 204 can be configured to automatically select all updates in the list or a subset of the updates in the list based on user settings/configurations. Selection UI 202 allows a user (e.g., system administrator) to see a display of the filtered list of software updates and to make selections based on whatever criteria and/or preferences are deemed relevant by the user.

A user can also select a business action for a selected software update. For example, a user might receive a list of multiple software updates for a remote system; the user could then select a different business action for each of the software updates. Examples of business actions include, but are not limited to, accepting (e.g., downloading) an update, postponing an update, or rejecting an update. Thus, the user could reject one of the updates and postpone the others; or the user could accept all of the updates.

Based on the selections passed from selection agent 116, business action agent 118 incorporates the selected software updates into business actions. In one embodiment, business action agent 118 incorporates a selected software update into a change management process.

A change management process allows for controls (e.g., quality controls, organizational controls, etc.) record-keeping with respect to changes in a system. Changes can be emergency corrections, periodic maintenance (e.g., applying a support package), or implementations and upgrades. In general, a change management process begins when a change is requested by a user (e.g., via a change request). In order to proceed with the change, the change request must be approved by a change manager. If the change request is approved, a developer or an administrator applies the change to a development system. The change is then passed to a test system where a user performs a test. If the test is successful the change is transported into the productive system for which the request was originally made. The complete process is recorded in the change request and is available for reporting.

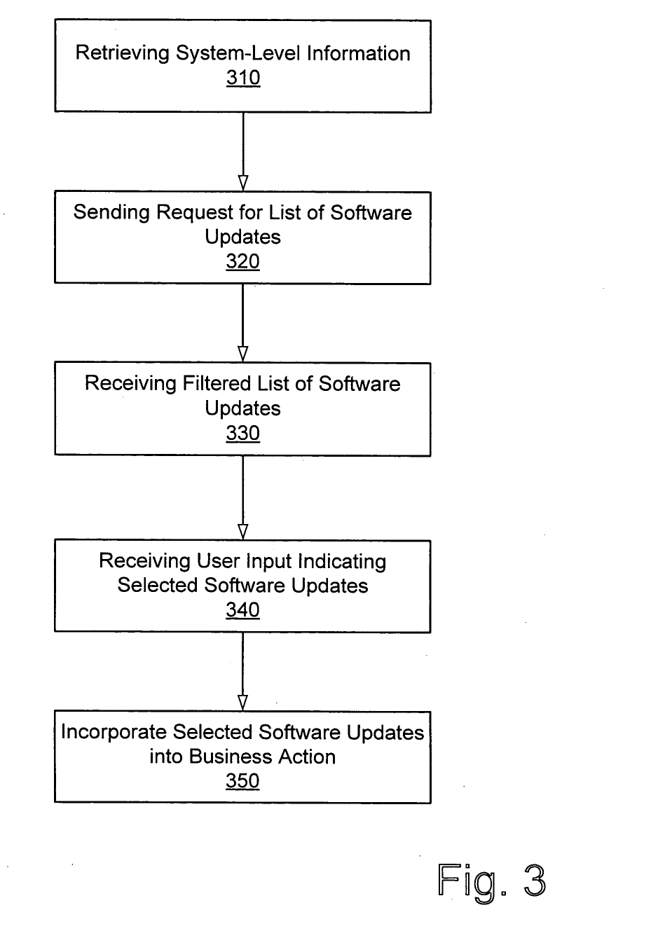

FIG. 3 is a flow diagram illustrating an embodiment of a process to manage software updates. A server (e.g., enterprise server) retrieves system-level information from a remote system 310. A remote system can be any combination of one or more devices that use software and are communicatively connected to the server (e.g., via a LAN, VLAN, WLAN, etc.). System-level information is retrieved by the enterprise server using any variety of communication protocols such as XML, HTTP, SOAP, etc. System-level information can include any information related to the software running on the system (e.g., current versions, support package levels, software components levels, timestamps to determine date of most recent changes, etc.); hardware information related to the software (e.g., minimum system requirements, etc.) can also be included.

The retrieved system-level information is sent to an update server with a request for a list of available software updates 320. The request can be an automatic request or a manual (e.g., user generated) request. Automatic requests can be sent on a periodic schedule based on user input/definitions. A request may also include business component designations for the remote system. For example, in a large corporate environment that has a large system landscape, there might be hundreds of devices running various combinations of software. Thus, it can be helpful to organize the software update process by dividing the system landscape into logical business components (e.g., accounting, information technology (IT), sales, etc.). To accomplish this, software products (e.g., applications) are associated with a particular business component.

The update server processes the request and generates a list of software updates that are relevant to the remote system (i.e., based on the retrieved system-level information.). The filtered list of software updates is received by the enterprise server 330. If business component designations are used, the list of software updates is divided/organized based on the business component designations.

Subsequent to receiving the filtered list of software updates, the enterprise server may receive user input indicating a selection of one or more software updates 340. The user input is received via a selection user interface (UI). The selection UI allows a user not only to select various software updates but also to select a business action to associate with a particular software update.

Selected software updates are incorporated into a business action 350. A business action can include any action taken on the selected software updates. For example, software updates can be selected for rejection. Rejecting the software updates can be a business action. Perhaps a particular software update is a patch for software bug. A user may choose to reject the patch in favor of an internally created patch that solves the same problem. Another business action is to postpone a particular software update. For example, there might be a received software update that includes a new version of an application used specifically within an accounting department. If the accounting department is currently using the application for an important project, a user (e.g., an administrator) may select to postpone installation of the new version until the accounting department is finished with the project.

Yet another business action is to accept a selected software update. In one embodiment, an accepted update is automatically downloaded and installed on the remote system. In another embodiment, an accepted update is incorporated into a change management process (either automatically or by user selection). A change management process allows a change manager or other supervisor, etc., to manage and/or supervise changes in a system to ensure quality control, to prevent change conflicts, etc. Changes can be emergency corrections, periodic maintenance (e.g., applying a support package), or implementations and upgrades.

In one embodiment, a change management process begins when a change is requested by a user (e.g., via a change request). For example, when a user (via a selection UI in the enterprise server) selects a software update received from an update server, the user can initiate a change request (or it can be initiated automatically). In order to proceed with the change, the change request must be approved by a change manager. If the change request is approved, a developer or an administrator applies the change to a development system. The change is then passed to a test system where a user performs a test. If the test is successful the change is transported into the productive system for which the request was originally made. The complete process is recorded in the change request and is available for reporting.

Embodiments of the invention described above may include hardware, software, and/or a combination of these. In a case where an embodiment includes software, the software data, instructions, and/or configuration may be provided via an article of manufacture by a machine/electronic device/hardware. An article of manufacture may include a machine/computer accessible/readable medium having content to provide instructions, data, etc. The content may result in an electronic device, for example, a disk, or a disk controller, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media such as read only memory (ROM), random access memory (RAM), magnetic disk storage media, optical storage media, flash memory devices, etc. The machine accessible medium may further include an electronic device having code loaded on a storage that may be executed when the electronic device is in operation. Thus, delivering an electronic device with such code may be understood as providing the article of manufacture with such content described above.

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
retrieving current system-level information for a remote system;
automatically sending a request to an update server for a list of software updates for the remote system, wherein the request includes the retrieved system-level information;
receiving from the update server a filtered list of one or more available software updates, wherein the filtered list is filtered based at least in part on the retrieved system-level information;
receiving user input indicating one or more software updates selected from the filtered list; and
incorporating the selected software updates into a business action.

2. The method of claim 1, wherein the request is sent according to a user-defined periodic schedule.

3. The method of claim 1, wherein the system-level information includes at least one of a software component version, a support package level, a software component version timestamp, and a support package level timestamp.

4. The method of claim 1, wherein the filtered list of available software updates is further filtered based at least in part on business component designations for the remote system.

5. The method of claim 4, wherein the business component designations are user-customized.

6. The method of claim 1, wherein incorporating the selected software updates into a business action comprises incorporating the selected software updates into a change management process.

7. The method of claim 6, further comprising:
receiving user input indicating a modification to the one or more selected software updates; and
updating the change management process based on the modification.

8. The method of claim 1, wherein the business action is selected from the group consisting of a postponement action and a rejection action.

9. An article of manufacture comprising a computer-readable medium having content stored thereon to provide instructions to result in an electronic device performing operations including:
retrieving current system-level information for a remote system;
automatically sending a request to an update server for a list of software updates for the remote system, wherein the request includes the retrieved system-level information;
receiving from the update server a filtered list of one or more available software updates, wherein the filtered list is filtered based at least in part on the retrieved system-level information;
receiving user input indicating one or more software updates selected from the filtered list; and
incorporating the selected software updates into a business action.

10. The article of manufacture of claim 9, wherein the system-level information includes at least one of a software component version, a support package level, a software component version timestamp, and a support package level timestamp.

11. The article of manufacture of claim 9, wherein the filtered list of available software updates is further filtered based at least in part on business component designations for the remote system.

12. The article of manufacture of claim 11, wherein the business component designations are user-customized.

13. The article of manufacture of claim 9, wherein incorporating the selected software updates into a business action comprises incorporating the selected software updates into a change management process.

14. The article of manufacture of claim 13, further having content to provide instructions to result in the electronic device performing additional operations including:
receiving user input indicating a modification to the one or more selected software updates; and
updating the change management process based on the modification.

15. The article of manufacture of claim 9, wherein the business action is selected from the group consisting of a postponement action and a rejection action.

16. A software update manager for a computer system, comprising:
a retriever to retrieve current system information from the system;
a requester coupled with the retriever to automatically send a request for a list of software updates for the system, wherein the request includes the retrieved system information;
an update agent coupled with the requester to process the request and respond by providing a filtered list of one or more available software updates, wherein the filtered list is filtered based at least in part on the retrieved system information;
a selection agent to facilitate a selection of one or more software updates selected from the filtered list; and
a business action agent coupled with selection agent to incorporate selected software updates into a business action.

17. The update manager of claim 16, wherein the business action is a change management process.

18. The update manager of claim 17, wherein the selection agent receives user input indicating a modification to the one or more selected software updates and the business action agent updates the change management process.

19. The update manager of claim 16, wherein the business action is selected from the group consisting of a postponement action and a rejection action.
